(19) United States
(12) Patent Application Publication
(10) Pub. No.: US 2002/0047802 A1
(43) Pub. Date: Apr. 25, 2002

(54) Patch antenna device

(76) Inventor: Veli Voipio, Helsinki (FI)

Correspondence Address: Michael B. Lasky, Altera Law Group, 6500 City West Parkway - Suite 100, Minneapolis, MN, 55344-7701, US

(21) Appl. No.: 09/854,817

(22) Filed: May 14, 2001

Related U.S. Application Data
(63) Continuation of application No. PCT/EP98/07391, filed on Nov. 18, 1998.

(51) Int. Cl. H01Q 1/38; H01Q 1/48

(52) U.S. Cl. 343/700 MS; 343/846

(57) ABSTRACT

A patch antenna comprising a conductive ground plate (1), a conductive patch (2) arranged in parallel above said conductive ground plate (1), a feed conductor (6) for feeding said patch antenna, and a dielectric substrate material (5) arranged between the conductive ground plate (1) and the conductive patch (2), wherein the feed conductor (6) is connected to one side of the dielectric substrate material (5) and the conductive patch (2) is connected to another side of said electric substrate material (5). The dielectric material provided between the patch and the ground plate serves at increasing cross-polarization separation and matching the antenna impedance. Thus, cross-polar separation and increased bandwidth can be achieved within the patch antenne in a simple and cost-effective way. Moreover, an ordinary probe feed and coaxial cables can be used and precise small capacitance can be implemented.

### FIELD OF THE INVENTION

The present invention relates to a patch antenna device which can be used in an adaptive antenna array of a mobile communication network.

### BACKGROUND OF THE INVENTION

The number of users of mobile communication systems is growing fast and there is a need to increase the channel capacity in dense user areas and to increase the range of the cells in sparsely populated areas.

Mobile communication systems make use of the UHF frequency range which is suitable in many aspects but still does not allow enough channels for the users. The cellular system technology with power control and time-division multiple access (TDMA) technology already improves the channel capacity significantly. In addition thereto, the control of the antenna radiation pattern is seen as a very promising way to improve the capacity of the cellular systems.

The antenna radiation pattern can be controlled electronically if an antenna array is used. Therefore, antenna arrays and antenna elements for these arrays are required which could be used in adaptively controlled antenna systems for mobile communications and for radio channel sounders.

When developing a radio system using an array pattern control, one should be aware of the delay spread and the angular spread of the signals. These both can be measured with the help of an antenna array, where the amplitude and phase of the received pulses are measured and stored by a channel sounder system, giving the angles and timing of the received pulses.

In view of the fact that similar arrays and elements are used in adaptive antennas and channel sounders, the present invention relates to both types of antenna elements.

Adaptive antenna arrays are complex and intrinsically large items. On the contrary, antennas for mobile communication systems should be small and also reasonably prized. The size limitation is most urgent in handhold mobile units. Laptop computers, vehicular installations and base stations provide some more space for the antenna array or for unrestrained antenna positions.

In base stations, wide band antennas are required. However, a wide band antenna tends to be large due to the laws of the antenna radiation physics. In a mobile unit, a small electronically tunable narrow band antenna could be used.

In the upcoming UMTS (Universal Mobile Telecommunication System), a relative bandwidth of 20% (1880 . . . 2280 MHz) is required. Some applications may use only part of the available bandwidth, but since the duplex distance is 190 MHz, the minimum bandwidth is 10%. The requirement for the channel sounder at IRC is 2154 MHz carrier frequency and 100 MHz (5%) bandwidth.

Due to the size restrictions, microstrip patch antenna elements are preferably used as the antenna elements of the array structure for such mobile communication systems. However, conventional patch antennas have only narrow bandwidths, such that special techniques are required so as to achieve the required bandwidth.

Moreover, the base station antenna element should be able to separate two polarizations, wherein a cross polarization discrimination (XPD) of 20 dB between an angle of ±30° should be achieved. This is also desirable for the antenna of the mobile unit. The possibility of separating two polarizations enables polarization diversity, since two plane waves with different polarizations propagate in a different manner.

One possible way to implement the polarization diversity is to place the patch antennas so that they point to opposite directions, wherein the polarization is controlled by a phase difference of the feeds.

Another way is to use half-wave patch antennas which can be excited in orthogonal directions so as to simultaneously excite two separate polarizations. Therefore, two feeds can be used for the same antenna, one for each polarization. When both polarizations are received with the same antenna element, the location for each polarization is the same, which is an advantage in channel sounder measurements.

A thick substrate is needed to achieve the wide bandwidth. However, the thick substrate leads to a reduced polarization purity, i.e. an increased cross polarization, when a probe feed is used.

A possible solution to this problem is to use a half-wave patch on a thin substrate, and another half-wave patch with a thicker substrate on top of the lower patch as a second resonator to widen the bandwidth. The lower patch is fed by a short probe which does not cause too much cross polarization. Such a patch antenna is called a stacked half-wave patch antenna.

In patch antennas, particularly stacked patch antennas, impedance matching is a critical task for achieving the required high bandwidth. Impedance matching is usually performed by a component capacitor (chip capacitor). However, such a component capacitor requires a microstrip circuit feed system which has high losses and is difficult to design.

### SUMMARY OF THE INVENTION

It is therefore an object of the present invention to provide a patch antenna device having a high bandwidth and a high cross-polar separation, wherein impedance matching is performed in simple and cost-effective way.

This object is achieved by a patch antenna device comprising:

a conductive ground plate;

a conductive patch arranged in parallel above the conductive ground plate;

a feed conductor for feeding said patch antenna; and

a dielectric substrate material arranged between the conductive ground plate and the conductive patch, wherein the feed conductor is connected to one side of said dielectric substrate material and said conductive patch is connected to another side of said dielectric substrate material.

Accordingly, by providing the dielectric substrate between the conductive patch and the ground plate, a substrate capacitor is formed within the patch antenna so as to compensate the inductance of the feed conductor or produces a dual-resonant structure, to thereby increase the bandwidth of the antenna element.

Moreover, the substrate capacitor formed by the dielectric substrate material serves at reducing the cross polarization discrimination (XPD), since the capacitor reduces the effective length of the feed conductor.

Preferably, the feed conductor is formed by a center conductor of a coaxial feed, wherein the center conductor protrudes from the conductive ground plate towards the one side of the dielectric substrate material. In this case, a coaxial connector can be fixed to the conductive ground plate at a side opposite to the side from which the center conductor protrudes, wherein the center conductor is connected via a through hole of said conductive ground plate to said coaxial connector. Thus, an ordinary probe feed can be used together with coaxial cables, whereby production costs can be reduced, since a microstrip circuit feed system is not required.

The dielectric substrate material preferably can be a dielectric plate having a metallized bottom surface and an optional metallized top surface, wherein the dielectric plate is arranged in parallel with the conductive patch and the conductive ground plate.

The conductive patch can be a rectangular half-wave patch. In this case, the top surface of the dielectric plate can be in direct contact with the half-wave plate at a position between the center of the patch and the center of an edge of the half-wave plate, wherein the feed conductor is connected to a metal layer arranged at the bottom surface of the dielectric plate. Thereby, the inherent low cross-polarized level of the half-wave patch antenna can be lowered even more, since the length of the feed conductor between the conductive ground plate and the half-wave patch is reduced by the thickness of the dielectric plate.

A second dielectric plate can be arranged at a position between the center of the patch and the center of another edge of the half-wave plate so as to provide a second feed for another polarization, wherein the other edge extends orthogonal to the edge. Thereby, a high bandwidth and a low cross-polarized level can be achieved for two separate polarizations excited in two orthogonal directions within one patch antenna.

Preferably, a second rectangular half-wave patch is arranged above the half-wave patch. Thereby, the bandwidth advantage of the stacked patch antenna can be combined with the advantages of the dielectric feed in order to achieve an even lower XPD at a high bandwidth.

Alternatively, the conductive patch may be a quarter-wave patch shorted at one end. In this case, the dielectric substrate material forms an integrated capacitor which may either compensate for the probe inductance or produce a dual-resonant structure, based on its capacity and mechanical size. Both cases lead to an increased bandwidth of the patch antenna.

Moreover, the XPD is reduced by the capacitor provided between the conductive patch and the conductive ground plate.

Preferably, the dielectric substrate material is a dielectric plate having a metallized top and bottom surface and being arranged a predetermined distance from the shorted end. The feed conductor may be connected to the metallized bottom surface, wherein the quarter-wave patch is connected via another feed conductor to the metallized bottom surface.

The patch antenna may be arranged in an antenna array of a base station of a cellular communication network.

### BRIEF DESCRIPTION OF THE DRAWINGS

In the following, the present invention will be described in greater detail on the basis of a preferred embodiment with reference to the accompanying drawings, in which:

FIG. 1 shows a principle diagram of a stacked half-wave patch antenna having two feeds for two respective polarizations;

FIG. 2 shows one of the feeding portions of the stacked half-wave patch antenna according to the preferred embodiment of the present invention;

FIG. 3 shows a measured radiation pattern in the H-plane obtained from the stacked patch antenna according to the preferred embodiment of the invention; and

FIG. 4 shows a measured radiation pattern in the H-plane obtained from a stacked patch antenna according to the prior art.

### DESCRIPTION OF THE PREFERRED EMBODIMENT

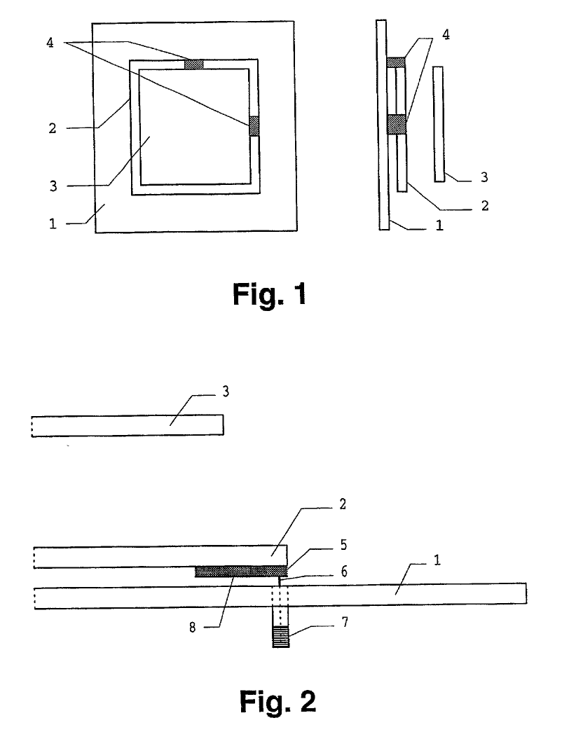

In the following, the preferred embodiment of the patch antenna according to the present invention will be described on the basis of a stacked half-wave patch antenna with two feeds, as shown in FIG. 1.

According to FIG. 1, the patch antenna is made of two half-wave patches 2 and 3 arranged on top of each other above a ground plate 1.

In the preferred embodiment, the antenna is designed for a 2154 MHz center frequency and for ±50 MHz bandwidth, since it is intended for use in a channel sounder system.

The patches 2, 3 and ground plate 1 are made of 0.5 mm thick copper plates. The dimensions of the lower patch 2 are 60 mm×60 mm and that of the upper patch 3 are 54 mm×54 mm. The lower patch 2 comprises two probe feed portions 4 which are symbolized as hatched portions in FIG. 1. The ground plate dimensions are 100 mm×100 mm.

The lower patch 2 is arranged 2 mm above the ground plate 1 and the upper patch 3 is arranged 5 mm above the upper side of the lower patch 2 and 2.5 mm above the ground plate 1.

In this type of antenna, a double resonance is generated so as to achieve a wide bandwidth, since the two patches 2 and 3 act like two coupled resonators.

Moreover, this type of antenna is easy to tune, because the upper patch 3 and the lower patch 2 can be connected via plastic nuts and bolts, such that tuning may be performed by adding or removing washers under the lower patch 2 and/or upper patch 3, or by replacing the lower patch 2 and/or upper patch 3 by a patch of different size.

FIG. 2 shows a partial side view of the stacked patch antenna according to FIG. 1. The patch antenna is fed using a probe which is essentially the center conductor 6 of a coaxial cable, where the outer conductor or shield is cut at the level of the ground plate 1 and the center conductor is protruded from said ground plate 1 via a through hole provided in the ground plate 1.

At both feeding portions which may be located at the center of the corresponding edge or edge portions of the lower patch 2, a substrate 5 is arranged at the lower surface of the lower patch 2 and forms a dielectric feed or feeder capacitor. Thereby, the center conductor or probe conductor 6 can be kept as short as possible. In particular, the probe conductor 6 is connected to a metal layer 8 provided at the bottom surface of the substrate 5. Thus, the substrate 5 is sandwiched between two metal layers so as to form the feeder capacitor. The metal layer 8 may be formed by a corresponding metallization of the respective surface of the substrate 5, wherein the lower surface of the lower patch 2 forms the metal layer at the other surface of the substrate 5.

It is to be noted that the feeding portions can be located at any position on a line between the center of the lower patch 2 and the center of the respective edge thereof, depending on the impedance matching.

In the present embodiment, the dimensions of the substrate 5 are 10 mm×10 mm×1, 27 mm and are arranged in pressure contact between the tip of the probe conductor 6 and the lower patch 2. Moreover, the substrate 5 is formed of a material having a dielectric contract εr=2.33, such that the resultant feeder capacitor has a capacity C=1.62 pF. in this case, the probe protrudes only 0.7 mm above the surface of the ground plate 1.

At the opposite side of the ground plate 1, a coaxial probe connector 7 is provided to which a coaxial cable can be connected as a signal line.

FIG. 3 shows a radiation pattern of the stacked patch antenna according to FIG. 1 and 2 measured in the H-plane. The upper continuous line shows a co-polar radiation pattern and the lower dotted line a cross-polar radiation pattern, wherein the received signal is measured at one feed and the other feed is terminated with a 50 Ω load. The co-polar radiation pattern indicates the received level of a polarization component corresponding to the measured feed, whereas the cross-polar radiation pattern indicates the received level of a polarization component to be received at other feed.

As can be gathered from FIG. 3, the maximum cross-polar level is −25.6 dB below the corresponding co-polar level. Moreover, the XPD, i.e. the logarithmic difference between the co-polar and the cross-polar level, is larger than 20 dB in a scanning angle ranging from −57° to +78°.

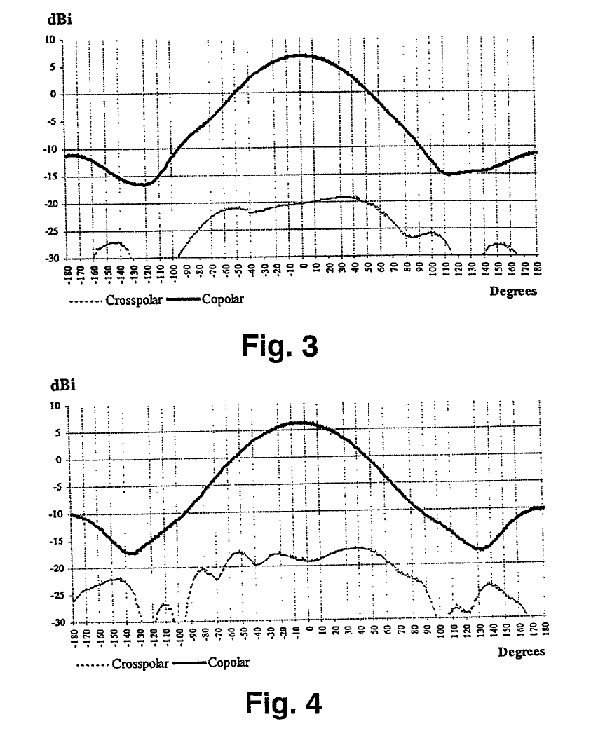

In comparison thereto, FIG. 4 shows a corresponding measured radiation pattern in the i-plane of a conventional stacked patch antenna without a dielectric feed. In this case, the maximum cross-polar level is −23 dB below the corresponding co-polar level of the boresight direction. The XPD is larger than 20 dB in a scanning angle ranging from −48° to +33°.

Thus, as can be gathered from the above radiation patterns according to FIGS. 3 and 4, the capacitor feed decreases the maximum cross-polar level by 2.6 and increases the scanning range in which the XPD is larger than 20 dB.

The best cross-polarization separation is obtained with a single feed antenna arrangement. Moreover, the dielectric feed should be relative small and well-centered in order to achieve a good cross-polarization separation.

In the normal operation of the patch antenna, a matched receiver is connected to the other feed, so that measurements are made with a matched load at the other feed. The matched feed will absorb cross-polar energy and an equal amount of energy is radiated back so as to level the dip in the middle of the H-plane cross-polar radiation pattern.

Good impedance matching reduces the cross-polar component and also the parameter S₂₁, because more power is radiated, and less power is transferred to the other feed, such that the power re-radiation is also decreased.

The dielectric feed is easy to manufacture and is inherently sturdy. Moreover, galvanic contacts are often favored by the industry, because components can be connected by using leads.

Thus, the stacked patch antenna with dielectric feed provides a feasible solution for dual-polarized arrays in a radio channel sounder.

However, it is to be noted that the dielectric feed shown in FIG. 2 is not limited to the stacked half-wave patch antenna depicted in FIG. 1. It may also be used in quarter-wave patch antennas, wherein a conductive patch is arranged above a conductive ground plate and shorted at one end. Thus, the patch consists of a part which is parallel to the ground plate and the shorting part connecting the parallel part with the ground plate. In this case, the probe feed may also be the center conductor of a coaxial connector, as shown in FIG. 2.

The dielectric substrate material which forms the feeder capacitor may be arranged in the middle or on top of the probe conductor. The feeder capacitor may also be formed by metallizing the dielectric substrate on the upper and lower side. In case of an arrangement of the feeder capacitor in the middle of the probe conductor, the upper metallized surface of the capacitor is connected via an additional probe conductor to the quarter-wave patch.

Thereby, the structure of the antenna can be regarded as a stacked patch antenna, wherein the dielectric substrate also functions as a coupling capacitor for the feed.

The position of the probe is used to determine the radiation resistance. Moving the probe towards the radiation end increases the radiation resistance. The probe should be positioned so that the real part of the antenna impedance is about 90 Ω at resonance. Increasing the diameter of the probe conductor will reduce the inductance thereof.

Such a quarter-wave patch antenna could be used in cellular base stations when a wide bandwidth is required and polarization separation is not necessary within one element. The antenna could be modified for mobile hand sets for example by using a substrate material of higher permittivity and by reducing the height. These modifications would shrink the size of the antenna but would also reduce the bandwidth, typically proportional to the volume. By using this design, it is possible to modify the antenna to an almost smallest possible antenna for the required bandwidth.

In summary, a patch antenna comprising a conductive ground plate, a conductive patch arranged in parallel above said conductive ground plate, a feed conductor for feeding said patch antenna, and a dielectric substrate material arranged between the conductive ground plate and the conductive patch, wherein the feed conductor is connected to one side of the dielectric substrate material and the conductive patch is connected to another side of said electric substrate material. The dielectric material provided between the patch and the ground plate serves at increasing cross-polarization separation and matching the antenna impedance. Thus, cross-polar separation and increased bandwidth can be achieved within the patch antenne in a simple and cost-effective way. Moreover, an ordinary probe feed and coaxial cables can be used and precise small capacitance can be implemented.

It is to be pointed out that the patch antenna described in the preferred embodiment is not restricted to the dimensions and materials described above. Any suitable conductive and dielectric material could be used for the patches, ground plate and dielectric substrate material, respectively. Moreover, the dielectric feed could be used in any kind of patch antenna. The preferred embodiment of the invention may thus vary within the scope of the attached claims.

1. A patch antenna device comprising:
a) a conductive ground plate (1);
b) a conductive patch (2) arranged in parallel above said conductive ground plate (1);
c) a feed conductor (6) for feeding said patch antenna; and
d) a dielectric substrate material (5) arranged between said conductive ground plate (1) and said conductive patch (2), wherein said feed conductor (6) is connected to one side of said dielectric substrate material (5) and said conductive patch (2) is connected to another side of said dielectric substrate material (5).

2. A patch antenna device according to claim 1, wherein said feed conductor is a center conductor (6) of a coaxial feed, said center conductor (6) protruding from said conductive ground plate (1) towards said one side of said dielectric substrate material (5).

3. A patch antenna device according to claim 2, wherein a coaxial connector (7) is fixed to said conductive ground plate (1) at a side opposite to the side from which said center conductor (6) protrudes, and wherein said center conductor (6) is connected via a through hole of said conductive ground plate (1) to said coaxial connector (7).

4. A patch antenna device according to any one of claims 1 to 3, wherein said dielectric substrate material is a dielectric plate (5) having a metallized bottom surface and an optional metallized top surface, said dielectric plate (5) being arranged in parallel with said conductive patch (2) and said conductive ground plate (1).

5. A patch antenna device according to claim 4, wherein said conductive patch (2) is a rectangular half-wave patch.

6. A patch antenna device according to claim 4, wherein a second rectangular half-wave patch (3) is arranged above said half-wave patch (2).

7. A patch antenna device according to claim 5 or 6, wherein the top surface of said dielectric plate (5) is in direct contact with said half-wave patch (2) at a position between the center of said half-wave patch (2) and the center of an edge of said half-wave patch (2) and wherein said feed conductor (6) is connected to a metal layer (8) arranged on the bottom surface of said dielectric plate (5).

8. A patch antenna device according to claim 7, wherein a second dielectric plate and feed conductor is arranged at a position between the center of said half-wave patch (2) and the center of another edge of said half-wave patch (2), said other edge extending orthogonal to said edge.

9. A patch antenna device according to any one of claims 1 to 3, wherein said conductive patch (2) is a quarter-wave patch shorted at one end.

10. A patch antenna device according to claim 9, wherein said dielectric substrate material is a dielectric plate having a metallized top and bottom surface and being arranged at a predetermined distance from said shorted end.

11. A patch antenna device according to claim 10, wherein said feed conductor is connected to said metallized bottom surface, and said quarter-wave patch is connected via another feed conductor to said metallized bottom surface.

12. A patch antenna device according to any one of claims 1 to 11, wherein said patch antenna is arranged in an antenna array of a base station of a cellular communication network.
